(19) United States
(12) Patent Application Publication
(10) Pub. No.: US 2024/0066592 A1
(43) Pub. Date: Feb. 29, 2024

(54) DEVICE AND METHOD FOR IMPROVING QUALITY IN AUTOMATED MACHINE-BASED CASTING METHODS BY IDENTIFICATION OF THE CAST PARTS BY PATTERN RECOGNITION AND STRUCTURE RECOGNITION

(71) Applicant: GIENANTH GMBH, Eisenberg (DE)

(72) Inventors: Hans-Juergen BRENNINGER, Freilassing (DE); Simon Werner GEIB, Kaiserslautern (DE)

(73) Assignee: GIENANTH GMBH, Eisenberg (DE)

(21) Appl. No.: 17/767,542

(22) PCT Filed: Oct. 12, 2020
(86) PCT No.: PCT/DE2020/000238

§ 371 Date: Apr. 8, 2022

(30) Foreign Application Priority Data
Oct. 16, 2019 (DE) 10 2019 007 188.3

(51) Int. Cl. B22D 46/00; B22C 11/08; B22C 19/04; B22D 29/04; G06T 7/00; G06V 20/52

(52) U.S. Cl. CPC B22D 46/00; B22C 11/08; B22C 19/04; B22D 29/04; G06T 7/0004; G06V 20/52; G06T 2207/30136; G06V 2201/06

(57) ABSTRACT

The invention relates to a device and method for improving the quality of automated machine-based casting methods by identification of the cast parts by pattern recognition and structure recognition, said method having the following features: Once the desired casting moulds (12) have been filled and monitored by means of sensors and cameras, and once the casting mould has been broken open, each finished cast part is identified by pattern recognition and pattern tracking, any flashing is removed, and the cast parts are fed to a jet cleaning process.

The present invention relates to an apparatus and a method for quality improvement in the automated machine-based casting method by means of identifying the cast parts by pattern recognition and structure recognition.

Metal production dates from the Copper Age, the time of transition from the Neolithic period to the Bronze Age. In antiquity, bronze was replaced by iron as the most important material, which in Europe was not capable of being cast until the Middle Ages.

During industrialization, cast iron became the most important construction material. By around 1900, series production parts were already being cast from aluminum for the automotive industry. In the 1970s, by the development of modern FEM simulation (method of finite elements) it became possible to simulate and optimize the casting process.

In respect of the prior art, reference is made at this point to Document DE 10 2015 102 308 A1. This is a method for labeling a cast part. According to the specifications in the description, the object of this method is to provide a method which makes it possible to produce cast parts that are permanently provided with readable information, in particular also in the state ready for use.

According to the specifications in patent claim 1, this object is achieved by a method for producing a cast part (G1, G2) provided with readable information (IG1, IG2), comprising the following working steps:
a) providing a labeling element (1, 20), which comprises on one side an information face (15, 22) provided with information (I1, I2) and, on another side, a cast part face (14, 21) which is assigned to the cast part (G1, G2) and on which there is likewise information (I1, I2);
b) arranging the labeling element (1, 20) in a casting mold (1) which delimits a mold cavity (7) replicating the cast part (G1, G2) to be cast, the labeling element (1, 20) being arranged on a casting mold face (10), assigned to the mold cavity (7) in such a way that the information face (15, 22) is covered in relation to the mold cavity (7), while the casting part face (14, 21) of the labeling element (11, 20) is assigned lying freely to the mold cavity (7);
c) pouring a metal melt (M) into the casting mold (1) while wetting the casting part face (14, 21) of the labeling element (11, 20) with metal melt (M);
d) solidifying the metal melt (M) to form the cast part (G1, G2), a material-, form- or force-fit connection of the labeling element (11, 20) to the cast part (G1, G2) being formed during the pouring or solidification, and the information (I1, I2) present on the cast part face (14, 21) being depicted in the manner of a stamp on the assigned face (18) of the cast part (G1, G2) during the pouring or the solidification of the metal melt (M);
e) removing the cast part (G1, G2) from the casting mold (1);
f) cleaning the cast part (G1, G2)

The methods for metal casting which are intended to place number parts or number stamps in the finished cast parts in order to identify them are very cost-intensive, susceptible to error and time-consuming, for which reason the object of the present application is to make do in all metal casting methods without manipulation of the model for the cast part identification, i.e. no part with a number or a continuous number stamping tool is installed or placed in the model.

This object is achieved by an apparatus for quality improvement in the automated machine-based casting method by means of identifying the cast parts by pattern recognition and structure recognition, having the following features:
a) after filling the desired casting molds (12) and monitoring them by means of sensors and cameras, the casting mold being broken, each finished cast part (24) is identified by pattern recognition and pattern tracking, the flashes are removed and the cast parts (24) are sent to jet cleaning (22),
b) each cast part (24) is identified when leaving the cleaning installation (22), the identifier face (47) is scanned by means of the camera (29) and forwarded to a measuring and testing station (40), cast part defects being captured,
c) the furthermore installed measuring devices in respect of the thickness (42) and possible cavity inclusions (33) lead to capture of the quality of the finished cast part (24),
d) the entire casting process is controlled by the big data computer and memory (61) for systemic data analysis, evaluation and interactive self-regulation of the process, and in that the measuring devices (42, 33), which are arranged in a station (40), are furthermore neighbored by a measuring device for casting structure defects (30), a measuring device for the surface structure (31) of the cast parts (24) and a measuring device (32) for measuring the outer contour of the cast parts (24), and in that high-resolution three-dimensional structure recordings of the surface of the cast parts (24) by the cameras (29, 34) are made possible by means of graphene-based light sensors, and in that the identifier face (47) is assigned individually to each cast part model, in that the cast parts (24) are sorted in respect of various quality criteria in a sorting device (38),
   as well as the method for quality improvement in the automated machine-based casting method by means of identifying the cast parts by pattern recognition and structure recognition, having the following features:
a) the production of a sand mold for forming the desired casting mold (24) for the liquid metal is supplemented by means of the subsequent filling and the subsequent alignment in running conveyor belts,
b) the further treatment of the casting molds (24) is accompanied by means of a very wide variety of sensors and cameras, the individual processing steps being accurately registered and the individual details being stored verifiably,
c) at each instant of the processing process, the state and the history of each cast part (24) is comprehensibly known,
d) the entire casting and manufacturing process is data-technologically subdivided in respect of the individual process steps and data connections into function-relevant categories and is controlled by the big data computer and memory (61) for systemic data analysis, evaluation and interactive self-regulation of the process, and in that graphene-based light sensors are used in order to identify the surface of the cast parts (24), and in that the measurement results of cast parts (24) from the measuring station (40) may be used for interactive self-control and regulation of the casting installation, and a computer program having a program code for carrying out the method steps when the program is run in a computer, and a machine-readable medium having the program code of a computer program for carrying out the method when the program is run in a computer.

The invention will be described by way of example with reference to an iron casting installation.

In detail:

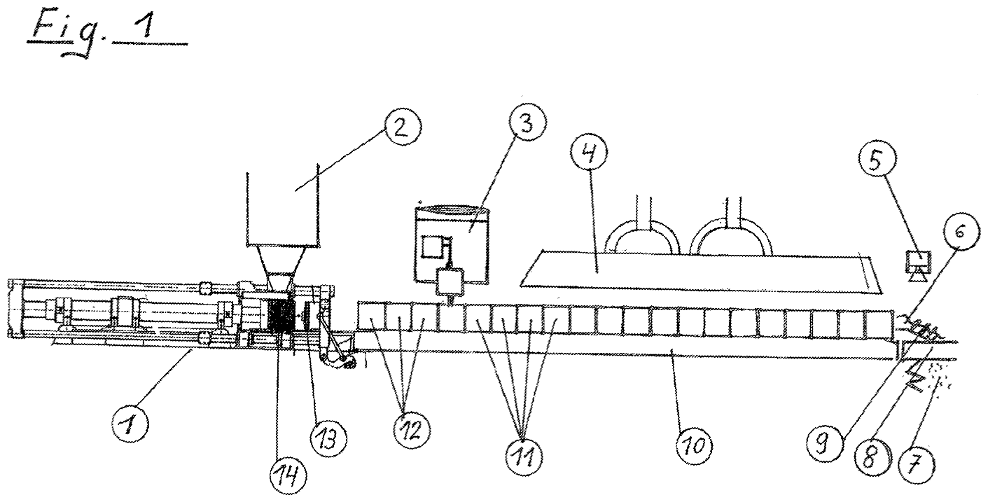

FIG. 1: shows the diagram of a casting installation in the region of mold formation, mold filling and mold cooling and the start of the mold breaking in a side view. In a mold pressing apparatus 1, with the front and rear model 13 of a series of sand preforms, a sand preform is respectively pressed from molding sand 7 (mold material), a front mold half and a subsequent mold half respectively forming a unit.

The supply of the required amount of sand, the closing of the respective sand mold and the closing of the sand pressing mold are monitored by means of sensors and cameras. The molding sand mixture (mold material) is stocked in the molding sand store 2 (mold material), and the properties of the molding sand 7 (mold material) may be manipulated by additives before filling into the sand pressing mold.

The filling level and the throughput of molding sand 7 in the molding sand store 2 are monitored by video and sensors.

After the formation, the molds 12 are conveyed successively to the casting apparatus with a friction fit and/or form fit on a transport path 10. In this case, the front mold 12 forms the second part of the rear mold 12. The casting apparatus 3 consists of a container for the so-called melt? (liquid metal, for cast iron the melting temperature is about 1400 degrees) and a filling apparatus for filling the sand molds 12. The filling is monitored by cameras and sensors as well as laser scanners. These parts are not shown here for the sake of clarity. The liquid metal is manipulated by so-called seeding before filling a casting mold 12. This means that required additives are delivered through a lateral channel (not shown here) into the liquid metal in order to correspondingly influence the product characteristics.

After filling the molds 12 in the casting apparatus 3, the row of molds 11 is conveyed at the rate of the mold production 1 on the transport path 10 through the cooling device 4 (the transport path 10 and the cooling device 4 are one unit) in the direction of a shaking apparatus 8. Through the rate of the mold production 1 and by means of the monitoring by sensors and cameras, the number of molds 11 and the respective position of a particular mold 11 on the entire transport path 10 are known. The cast parts 24 in the molds 11 may therefore be assigned to each particular mold 11.

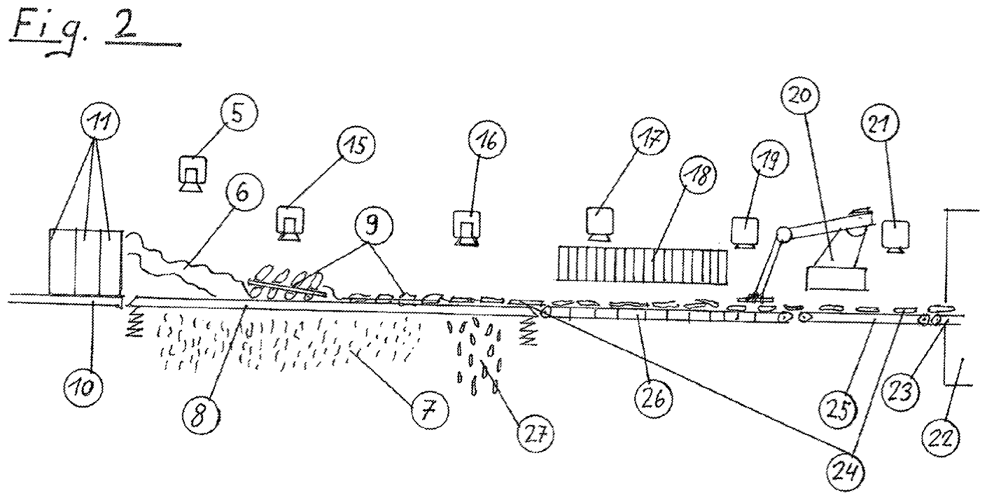

FIG. 2: FIG. 2 shows the diagram of the casting installation in the region of the mold breaking, the mold material removal, the flash and feeder removal, the after-cooling, the residual flash and feeder removal and the transport to the jet cleaning device in a side view.

On the left side, the transport path 10 of FIG. 1 with the filled molds 11 can be seen. Because of the timed forward feed of the mold production 1, the molds 11 are conveyed individually onto a shaking screen of a shaking apparatus 8. By the vibrations of the shaking apparatus 8, a mold 11 is respectively broken in the sand breaking region and the cast parts 9 together with the corresponding flashes and feeder parts emerge and remain on the shaking screen. The loose molding sand 7 is discharged downward through the shaking screen lying underneath and the conveyor belt. The molding sand 7 and the small flashes and small parts of the feeder system 27 are collected for reconditioning and reuse and returned into the production circuit.

The cameras 15 and 16 located above track the cast parts 24 freed from the loose molding sand 7 and from the loose flashes as far as the conveyor belt 26. Thermal imaging cameras are preferably used for the cameras 15 and 16.

By means of the conveyor belt 26, the cast parts 24 are sent through a second cooling device 18, a camera 17 (CCD) arranged above tracking the route. Depending on requirements, more cooling installations may also be installed in the installation.

After passing through the cooling device 18, the residual flashes and larger parts of the feeder system are removed by means of a gripping apparatus in the form of a six-axis robot. This procedure may also be carried out manually or with the aid of manipulators. The flashes 27 are jointly captured by a video camera 19 in the further tracking of the cast parts 24, and the captured data are used to control the flash removal 20 of the residual flashes and feeder parts.

With the camera 19, the cast parts 24 are tracked further as far as the conveyor belt 25 which transports the parts to the inlet of the jet cleaning 22.

On the conveyor belt 25, the video camera 21 located above takes over the part tracking as far as the jet cleaning apparatus 22, or the transport apparatus 23 of the jet cleaning 22.

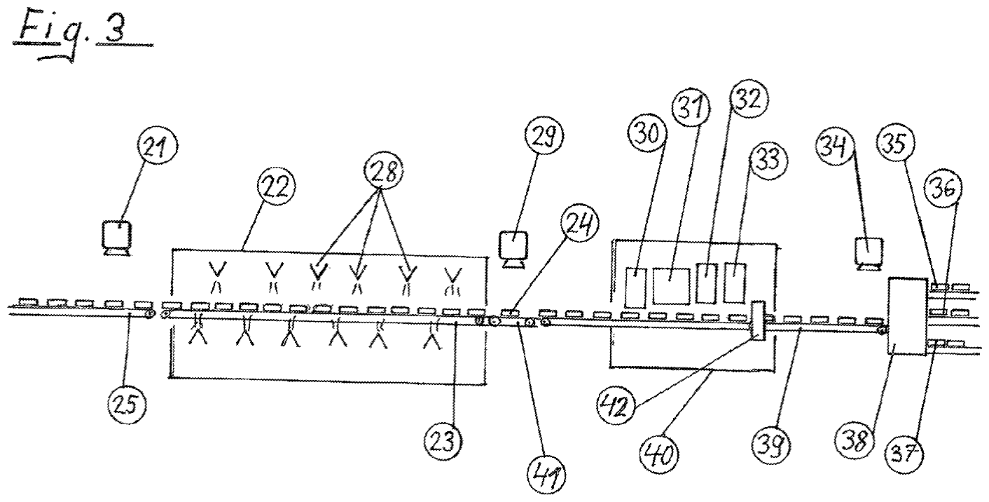

FIG. 3 shows a diagram of the casting installation in the region of the jet cleaning, the cast part scanning, the measurement and testing and the cast part sorting in a side view.

On the left side, we see the conveyor belt 25 which carries the cast parts 24 to the entry of the jet cleaning apparatus 22. The grid belt 23 of the jet cleaning apparatus 22 takes over the further transport through the jet cleaning apparatus 22.

During the jet cleaning, the cast parts 24 are cleaned of the residual contamination, for example incrustations of the molding sand, by means of bombardment with granules. This is done with the aid of granules which are accelerated by means of spinner wheels or compressed-air jet nozzles 28, which are respectively located above and below the conveyor grid belt 23 and are directed onto the cast parts.

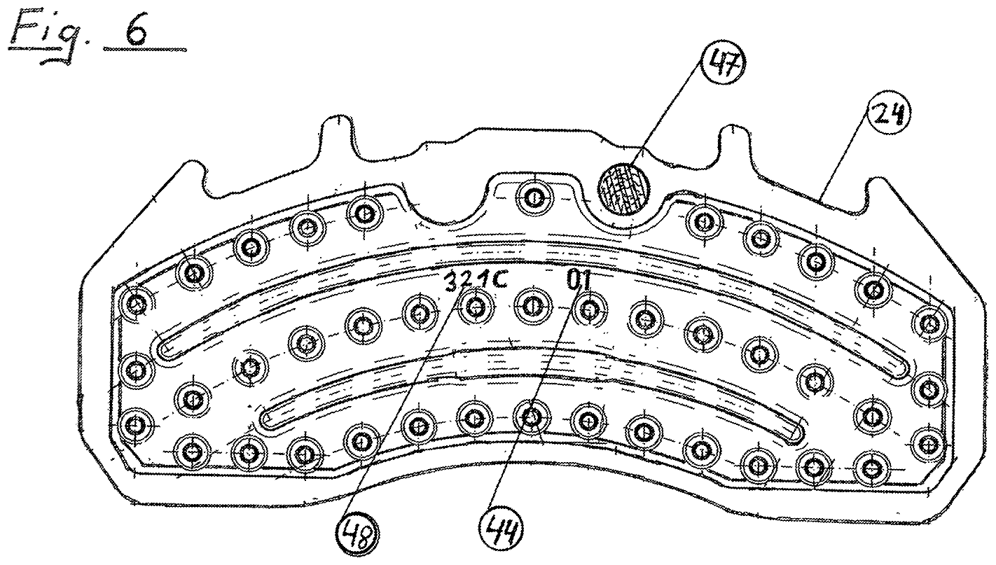

Depending on the particle size, material and shape of the granules, this cleaning method leaves behind a structure on the surface of the cast parts 24, as may be seen in FIG. 6. For each cast part, this structure acts as a homogeneous surface, but with greatly magnified observation is different for each cast part 24 at each location of the cast part 24. This property is used as an identification parameter for re-identifying each cast part 24. It is thus similar to the fingerprint of a human.

Over the start of the conveyor belt 25, there is the camera 21 which concludes the pattern tracking of the cast parts before the jet cleaning parts 22. By the video pattern recognition and the video pattern tracking, the data of each cast part 24 in respect of the mold from which it comes, and which casting nest 43 it belongs to, are known as far as the entry into the cleaning installation 22.

The cast parts 24 are taken up by the grid belt 23 and delivered with an accurately defined speed through the jet cleaning apparatus 22. In this way, each cast part 24 is re-identified by the camera until leaving the cleaning installation 22.

The cleaning installation is followed by a structure scan device consisting of the camera 29 and the transport device 41. The camera 29 is a high-resolution stereo video camera and or a scanning apparatus equipped with a high-resolution graphene light sensor.

The transport device 41 is mounted vibration-free in order to improve the quality of the scan recording.

After the scanning with the camera 29 and the storing of the data of the structure scan face 47 (see FIG. 6) for re-identifying the cast part 24, the cast parts 24 are delivered further by the conveyor belt 39 with an accurately defined speed to the measuring and testing station 40. Since the transport speed is known, the transport transit time of each cast part 24 may be used for checking the identifier face 47 by the camera 34 at the end of the conveyor belt 39. The cameras 29 and 34 may be fitted with graphene light sensors. This allows 3D structure recordings with high quality in order to improve the cast part identification. Graphene light sensors have a light sensitivity 1000 times higher than conventional light sensors and, by their layer construction, allow three-dimensional high-resolution recording of the surface in real time.

In the station 40, all the measurements take place in a continuous throughput testing method.

First, the cast parts 24 are checked for casting lattice defects by means of an eddy-current measuring device 30. In this case, the change in an applied electric field allows inference about the structure of the lattice of a cast part 24. The data obtained are analyzed and stored, and may later be assigned to the respective cast part 24.

Subsequently, a surface structure measurement 31 is carried out by means of lasers in order to check the surface of the cast parts for irregularities on the surface. Two lasers lying opposite one another are directed at a particular angle X onto the surface of the respective cast part at a point and synchronously scan the surface of the cast part 24. This creates a 3D profile of the respective surface, which is analyzed. The data of the measurement are assigned to the cast part 24 and stored. The data of the high-accuracy laser scan may likewise be used to check the scan data marking 47.

The cast part 24 is transported further and checked by means of the laser measuring device 32 in respect of the outer contours for planarity and curvature. The corresponding data are evaluated and stored for each cast part.

The cast part 24 is transported further on the belt 39 and checked by means of an ultrasound measuring apparatus 33 for cavity inclusions. The data for each cast part 24 are evaluated and stored.

The cast part 24 is transported further on the belt 39 and checked by means of a laser thickness measuring installation 42 in height for dimensional compliance. The lasers respectively scan the upper and lower edges of each cast part 24. The data obtained are evaluated and stored. The cast parts 24 are transported further on the conveyor belt 39 to the sorting installation 38.

Before entry into the sorting installation 38, the parts are captured with the camera 34 and identified using the structure scan face 47 by means of comparison of the stored structure data (reference pattern). The final check is carried out by comparison of the reference data with the measurement data which have been stored for each cast part 24.

In the sorting installation 38, the cast parts 24 are sorted in respect of various quality categories.

Exemplary category 35, cast parts with contour and thickness defects in category 36 and 37 with lattice and inclusion defects. These are cast parts which, for example, lie within the tolerance and are classified as good.

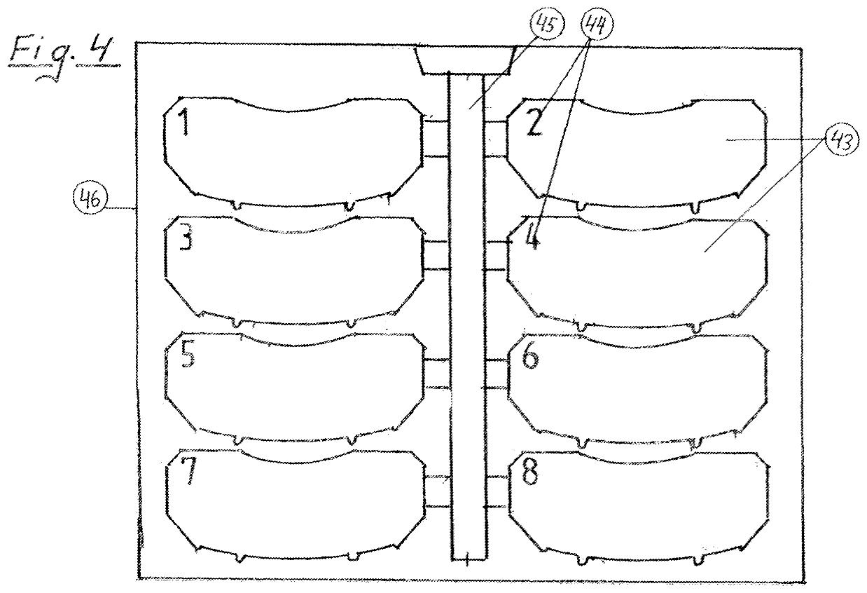

FIG. 4 shows the rear part of an empty sand casting mold 11 in front view.

The outer edge 46 forms the lateral boundary of the sand casting mold. During the filling of the mold 11, the liquid casting iron or an alloy of different metals and additives flows through the main casting channel into the mold 11 and is distributed in the casting nests 43, which form the cavities for the future cast parts 24. Each casting mold is provided, for example, with eight casting nests. Each casting nest 43 of the sand casting mold (11, 12, 14) is provided with a casting nest number 44. By the casting nest number 44, the placement or location of the casting nest 43 and later of the molded cast part 24 in the respective sand casting mold (11, 12, 14) is known. This feature of the casting number 44 is an important detail in the pattern recognition and pattern tracking and in the analysis of casting defects. In this way, after the breaking 6 of the sand mold 12, all cleaned cast parts 24 can be assigned to the respective sand casting mold.

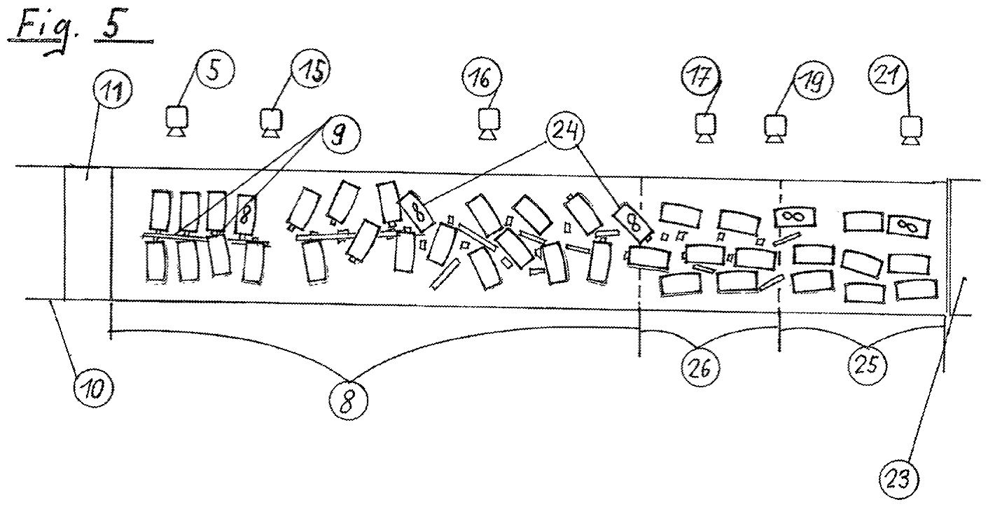

FIG. 5 shows a schematic representation of the cast part pattern tracking in the region of the casting installation between the casting mold transport path 10 and the jet cleaning conveyor belt 23 in plan view.

For example, after the breaking 6 of a mold 11, the placement of the cast part 23 from the casting nest 44 with the number 8 is shown on its transport route through the regions of the shaking screen 8, conveyor belt of the cooling installation 26, conveyor belt 25 to the jet cleaning installation. For reasons of clarity, we represent the pattern tracking, object tracking of only one cast part 24.

After the breaking of the mold 11 on the shaking apparatus 8, the cast parts are still connected to the flashes and feeder system parts 9. The cast parts 9 are captured by the video thermal image camera 5 and compared with the shape stored in the program and the placement parameters (classification). The technique of assigning the contents of digital images to a class of a classification system is an image analysis method. This may be subdivided into three subregions of segmentation, object recognition and image interpretation. The pattern recognition or object recognition is carried out by means of contour segmentation on the basis of edges or discontinuities. In this way, the identified cast parts 24 are observed and detected in the pattern tracking program by means of their classifier assigned by the program with the cameras 15, 16, 17, 21 in the regions of the shaking screen 8, conveyor belt of cooling installation 26, conveyor belt 25 to the jet cleaning installation as far as the conveyor belt 23. Here, the transport placement variation of the cast part with the casting nest number 8 on its way to the conveyor belt 23 of the jet cleaning installation 22 is shown.

FIG. 6 shows a cast part 24 by way of example in the form of a support plate for brake pads in plan view. After the cast part 24 has left the jet cleaning 22 (see FIG. 3) and been captured by the camera 28 and transmitted as a high-resolution image to a data processing installation, the heuristic approach is adopted and a reference pattern of the surface structure of each cast part 24 is compiled. An image processing and analysis program selects a previously location-determined and size-defined section 47 (identification face) on the surface of the cast part 24 and compiles a reference pattern from its surface structure. The location of the identifier face 47 is established beforehand for each cast part model 13. It is determined by means of the model number 48 identified, which is likewise stored as a reference. The size of the identifier face 47 is dependent on the surface structure of the cast part 24 and the amount of data generated. In the case of a fine structure, more data are generated on the same face than in the case of a coarse structure. The size of the amount of data is thus adapted and the identifier face 47 is reduced to a sufficient extent. With the reference pattern, a so-called classifier is generated and is stored for each cast part, so as to identify the cast part during the subsequent scanning of the identifier face 47. The casting nest number 44 identified contains information as described in FIG. 4, which is stored with the classifier. The measurement data of each cast part 24 from the measuring station 40 are likewise stored in the memory with the classifier for the respective cast part 24.

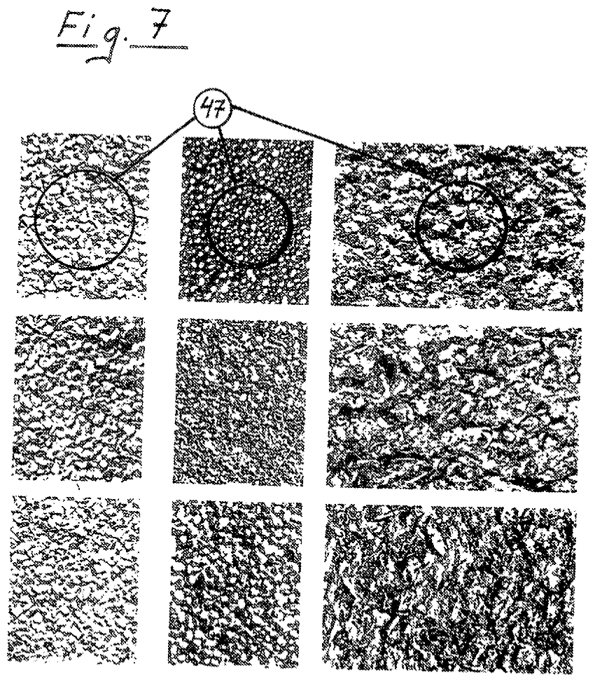

FIG. 7 shows by way of example various surface structures of jet-cleaned cast parts 24, such as are created with various jet granules.

Crucial for this are the size and shape and the hardness of the jet granule particles. The surfaces shown in the left column are generated with fine amorphous silicate particles. The surfaces shown in the middle column are generated with small round jet spheres. The surfaces shown in the right column are generated with coarse amorphous silicate particles. The size of the identifier face 47 in relation to the structure pattern of the surface is shown in the upper row of the structure recordings.

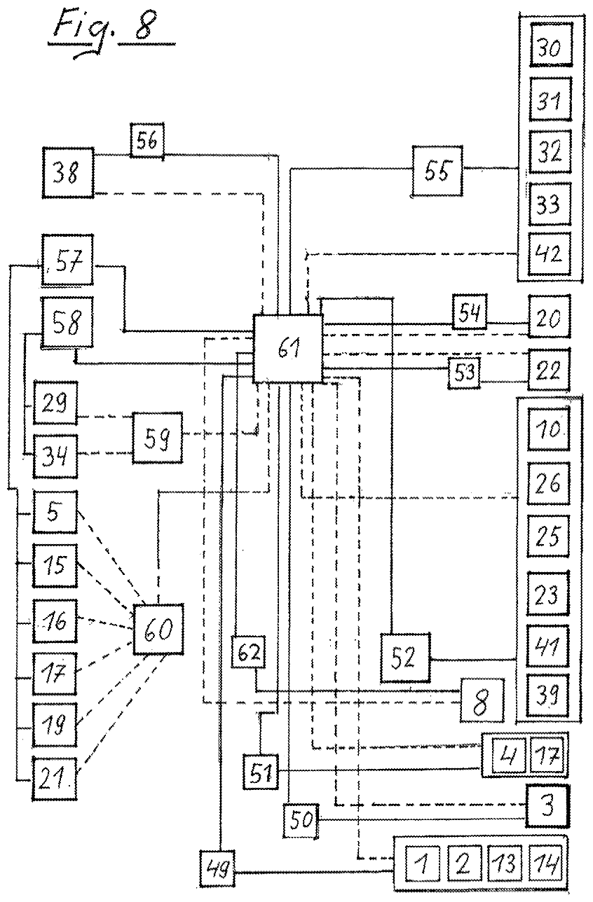

FIG. 8 shows a block diagram of all relevant components of the casting installation with the data connections and the control connections to the data processing modules for the casting process. For the sake of clarity, the components are divided into five categories of the overall machine casting installation process.

Category 1: is the cast part formation process with the following components: mold formation component consisting of the installation parts 1, 2, 13, 14, with the control module 49, the casting component 3 with the controller 50, the cooling components 4, 17 with the controller 50, the mold release component 8 with the controller 62, the residual flash removal 20 with the controller 54 and the cleaning component 22 with the controller 53 and the respective transport apparatuses 10, 26, 25, 23, 41, 39, with the controller 52. The sensors for the molding sand humidity, compressibility, mold material composition, the mold material temperature, the pressing pressure, (the adjustment parameters of the molding installation in general), the video sensor for the mold closure monitoring, the temperature sensor for the feeder temperature monitoring, the video sensor and the laser sensor for the mold filling monitoring.

Cooling temperature sensors, placement sensors of the transport apparatuses and the shaking apparatus 8, sound sensors, sensors of the residual flash removal 20, air pressure sensors and granule throughput sensors of the cleaning apparatus 22, rotational speed sensors of the transport apparatuses and other monitoring devices of the manufacturing process are not represented for reasons of clarity.

Category 2: the cast part measuring and testing process with the components: material lattice testing 30, 33, surface testing 31, contour testing 32, thickness testing 42 with the controller 55 and the stored data of the material composition of the chemical analysis, the previous treatment temperature and the origin of the melt.

Category 3: cast part recognition and tracking process with the components 5, 15, 16, 17, 19, 21 and the image processing module 60 and the controller 57.

Category 4: cast part marking and identification in the process by the components 29, 34, and the controller 59.

Category 5: cast part sorting process with the components: sorting installation 38 and the controller 56, the sensors for the transport placement monitoring, drive monitoring, scan sensors of the sorting function monitoring are not represented for reasons of clarity. The sensor data of Category 1 are transmitted to the data processing 61 via the data processings (shown here by dashes) and contain information relating to the actual state of the instantaneous manufacturing installation.

The sensor data of Category 2 are transmitted to the data processing 61 (dashed line) and contain information relating to the respective state of the cast part 24 being tested. The video data of the cameras of Category 3 are transmitted to the image processing 60, and the cast parts 24 are identified with the aid of a pattern recognition program based on contour segmentation, as described in FIG. 5. Furthermore, the video data are observed and determined with the aid of a pattern tracking program based on the polar check method as far as the component 22 (jet cleaning). The polar check method is a very reliable method for pattern recognition and pattern tracking. The polar check method consists in drawing one or more circles around the center of mass of the object and determining the points of intersection of the circles with the contour. Depending on the requirement for the classification capability, the features may be found in two ways. In Method 1, the number of points of intersection with the respective radii is more accurate. The number of points of intersection is compared with those of the reference pattern. Method 2, the polar check method, uses the angle differences which arise when the points of intersection are connected to the centers of mass of the objects. The maximum correlation of the angle difference sequence of the objects with those of the reference objects is sought. The data extracted from the image processing 60 are transmitted via the data connection to the data processing 61 for analysis, evaluation and control. The scan data of each cast part 24 from Category 4 for the pattern identification, as also described in FIG. 6, are extracted in the image processing 59 by a special program and transmitted to the data processing for analysis, evaluation, storage and control. The sensor data of the sorting process of Category 5 with the components 38 and the controller are transmitted via the data connection to the data processing 61 for analysis, evaluation and control.

All data of Categories 1 to 5 are collected in the data processing 61, also referred to as big data, and delivered by a systematic data analysis program with an evaluation system as extracted data to the production data set in order to be used for active control and regulation and for interactive self-regulation by special programs of the overall manufacturing process.

### LIST OF REFERENCES

1 molding apparatus
2 molding sand (mold material) store
3 casting apparatus
4 cooling (precooling)
5 first camera of the pattern recognition
6 mold breaking
7 molding sand (mold material)
8 shaking and screening device
9 cast parts with flashes and feeder system parts
10 transport path
11 filled mold
12 empty mold
13 model
14 pressed sand mold
15 second camera of the pattern recognition and pattern tracking
16 third camera of the pattern recognition and pattern tracking
17 fourth camera of the pattern recognition and pattern tracking
18 cooling (final cooling)
19 fifth camera of the pattern recognition and pattern tracking
20 apparatus for residual flash and feeder system parts removal
21 sixth camera of the pattern recognition and pattern tracking
22 cast part jet cleaning apparatus
23 conveyor belt to the jet cleaning apparatus
24 cast part
25 conveyor belt to the jet apparatus 22
26 conveyor belt of the cooling installation
27 small flashes
28 jet nozzles/spinner wheels
29 seventh camera (scan, structure recordings, graphene light sensor)
30 lattice measuring device (eddy-current measurement)
31 surface structure measuring device (laser)
32 contour measuring device (laser)
33 lattice and cavity identification (ultrasound)
34 eighth camera (final check, graphene light sensor)
35 cast part with contour defect, thickness defect
36 cast part with lattice defect
37 cast part without defect
38 sorting device for cast parts
39 conveyor belt of the measuring station (40)
40 measuring station for quality control
41 conveyor belt of the scan device with stop function
42 thickness measuring device (laser)
43 casting nests
44 nest number
45 casting channel (feeder)
46 sand casting mold (outer edge)
47 structure scan face (identifier face)
48 model number
49 control module of the mold formation with components 1, 2, 13, 14
50 control module of the casting installation 3
51 control module of the cooling installation 4, 17
52 control module of the transport apparatuses 10, 26, 25, 23, 41, 39
53 control module of the jet cleaning apparatus 22
54 control module of the residual flash removal
55 control module of the measuring apparatuses 30, 31, 32, 33, 41
56 control module of the sorting apparatus 38
57 control module of the video cameras 5, 15, 16, 17, 19, 21
58 control module of the scan device 29, 34
59 image processing for scan device 29, 34
60 image processing for pattern recognition and pattern tracking for the data of the cameras 5, 15, 16, 17, 19, 21
61 big data computer and memory for systemic data analysis, evaluation and interactive self-regulation of the process
62 control module of the shaking and screening device

We claim:

1. An apparatus for quality improvement in the automated machine-based casting method by means of identifying the cast parts by pattern recognition and structure recognition, having the following features:
e) after filling the desired casting molds (12) and monitoring them by means of sensors and cameras, the casting mold being broken, each finished cast part (24) is identified by pattern recognition and pattern tracking, the flashes are removed and the cast parts (24) are sent to jet cleaning (22),
f) each cast part (24) is identified when leaving the cleaning installation (22), the identifier face (47) is scanned by means of the camera (29) and forwarded to a measuring and testing station (40), cast part defects being captured,
g) the furthermore installed measuring devices in respect of the thickness (42) and possible cavity inclusions (33) lead to capture of the quality of the finished cast parts (24),
h) the entire casting process is controlled by the big data computer and memory (61) for systemic data analysis, evaluation and interactive self-regulation of the process.

2. The apparatus as claimed in claim 1, wherein in that the measuring devices (42, 33), which are arranged in a station (40), are furthermore neighbored by a measuring device for casting lattice defects (30), a measuring device for the surface structure (31) of the cast parts (24) and a measuring device (32) for measuring the outer contour of the cast parts (24).

3. The apparatus as claimed in claim 1, wherein in that high-resolution three-dimensional structure recordings of the surface of the cast parts (24) by the cameras (29, 34) are made possible by means of graphene-based light sensors.

4. The apparatus as claimed in claim 1, wherein in that the identifier face (47) is assigned individually to each cast part model.

5. The apparatus as claimed in claim 1, wherein in that the cast parts (24) are sorted in respect of various quality criteria in a sorting device (38).

6. A method for quality improvement in the automated machine-based casting method by means of identifying the cast parts by pattern recognition and structure recognition, having the following features:
e) the production of a sand mold for forming the desired casting mold (24) for the liquid metal is supplemented by means of the subsequent filling and the subsequent alignment in running conveyor belts,
f) the further treatment of the casting molds (24) is accompanied by means of a very wide variety of sensors and cameras, the individual processing steps being accurately registered and the individual details being stored verifiably,
g) at each instant of the processing process, the state and the history of each cast part (24) is comprehensibly known,
h) the entire casting and manufacturing process is data-technologically subdivided in respect of the individual process steps and data connections into function-relevant categories and is controlled by the big data computer and memory (61) for systemic data analysis, evaluation and interactive self-regulation of the process.

7. The method as claimed in claim 6, wherein in that graphene-based light sensors are used in order to identify the surface of the cast parts (24).

8. The method as claimed in claim 7, wherein in that the measurement results of cast parts (24) from the measuring station (40) may be used for interactive self-control and regulation of the casting installation.

9. A computer program having a program code for carrying out the method steps as claimed in claim 6, when the program is run in a computer.

10. A machine-readable medium having the program code of a computer program for carrying out the method as claimed in claim 6, when the program is run in a computer.
